(19) United States
(12) Patent Application Publication
(10) Pub. No.: US 2025/0018505 A1
(43) Pub. Date: Jan. 16, 2025

(54) Device for Working a Surface of a Workpiece With a Laser Beam

(71) Applicant: Plasmatreat GmbH, Steinhagen (DE)

(72) Inventor: Christian Buske, Bielefeld (DE)

(21) Appl. No.: 18/711,964

(22) PCT Filed: Nov. 22, 2022
(86) PCT No.: PCT/EP2022/082802

§ 371 Date: May 21, 2024

(30) Foreign Application Priority Data
Nov. 22, 2021 (DE) 10 2021 130 466.0

(51) Int. Cl. B23K 26/14; B23K 10/00; B23K 26/067; B23K 26/352

(52) U.S. Cl. CPC B23K 26/1462; B23K 10/00; B23K 26/0673; B23K 26/352

(57) ABSTRACT

A device for working a surface of a workpiece with a laser beam, with a laser system for providing the laser beam and with a plasma nozzle which is configured to generate an atmospheric plasma jet. The plasma nozzle having a nozzle head from which a plasma jet generated in the plasma nozzle emerges during operation. The laser system and the plasma nozzle are arranged relative to one another and configured in such a way that the laser beam emerges from the nozzle head of the plasma nozzle during operation, and wherein the nozzle head can be rotated about an axis of rotation (R) which extends at an angle and/or offset with respect to the plasma jet emerging from the nozzle head during operation and/or with respect to the laser beam emerging from the nozzle head during operation. The invention also relates to a method for operating such a device.

### CROSS-REFERENCE TO RELATED APPLICATIONS

This application is the United States national phase of International Application No. PCT/EP2022/082802 filed Nov. 22, 2022, and claims priority to German Patent Application No. 10 2021 130 466.0 filed Nov. 22, 2021, the disclosures of which are hereby incorporated by reference in their entireties.

### BACKGROUND OF THE INVENTION

### Field of the Invention

The present invention relates to a device for working a surface of a workpiece with a laser beam, with a laser system for providing the laser beam and with a plasma nozzle which is configured to generate an atmospheric plasma jet, wherein the plasma nozzle has a nozzle head from which a plasma jet generated in the plasma nozzle emerges during operation, and wherein the laser system and the plasma nozzle are arranged relative to one another and configured in such a way that the laser beam emerges from the nozzle head of the plasma nozzle during operation. The invention also relates to a method for working a surface of a workpiece with such a device.

In the context of this description, working is understood to mean in particular the working of a surface with a laser beam, by means of which surface properties, such as the structure or composition of the surface, can be modified in a targeted manner and optimized for various applications.

It is known from the state of the art to use a laser beam to clean surfaces of various materials, to remove layers or to modify them in a targeted manner in a discrete area. In particular, working the surface of a workpiece with a laser beam can prepare it specifically for subsequent process steps. For example, working with a laser beam is preferably used to pre-treat surfaces for bonding, welding, soldering or painting.

Working the surface of a material with a laser beam is also often used to make the surface more resistant to stresses. Processes such as laser hardening, laser remelting and laser coating can, for example, increase hardness and toughness and change the surface structure. Working the workpiece surface with a laser beam can also improve the wear or corrosion protection of the workpiece. It is also known that a surface can be labeled or marked by working it with a laser beam.

It is further known to use a plasma jet to improve the working of a surface with a laser beam by advantageously modifying the surface properties through treatment with the plasma jet prior to the working. For example, the plasma jet can be used to change, preferably improve, the absorption properties of the surface in relation to the laser beam. In this way, the energy coupling of the laser beam into the surface can be made more effective and, for example, the material removal by means of the laser can be increased.

When working a surface with a laser beam, especially when removing layers such as during surface cleaning, some of the removed particles often deposit on the surface again. For example, it is often the case that the removed contaminants deposit on the workpiece surface and contaminate it again. The re-deposition of the removed material can also cause undesirable mixed layers to form on the workpiece surface. This can lead to an irregular workpiece surface and altered material properties in the vicinity of the worked area.

To overcome this problem, it is known to direct a plasma jet onto the area to be worked on the workpiece surface in addition to the laser beam. The plasma jet can decompose or transform the material removed by the laser beam so that it is no longer deposited on the workpiece surface.

### Description of Related Art

WO 2017/178580 A1 discloses a device for working a surface of a workpiece with a laser beam, in which a plasma nozzle is used to generate an atmospheric plasma jet, which emerges from the plasma outlet opening of the plasma nozzle together with the laser beam during operation.

However, it has not yet been possible to effectively work a surface with a laser beam and a plasma jet on larger workpiece surfaces. In particular, the uniform working of larger workpiece surfaces proves to be difficult. The interaction between the laser beam and plasma jet, in particular possible absorption of the laser beam by the plasma, can also have a detrimental effect on the intensity of the laser beam in the device known from the prior art, so that insufficient working of the workpiece surface with the laser beam can occur. In addition, it was found that the detachment of large quantities of material by the laser beam can also lead to their undesirable deposition on the workpiece surface.

### SUMMARY OF THE INVENTION

The present invention is based on the technical problem of further developing a device for working the surface of a workpiece with a laser beam in such a way that at least one or more of the aforementioned disadvantages are at least partially eliminated.

With a device for working a surface of a workpiece with a laser beam, with a laser system for providing the laser beam and with a plasma nozzle which is configured to generate an atmospheric plasma jet, wherein the plasma nozzle has a nozzle head from which a plasma jet generated in the plasma nozzle emerges during operation, and wherein the laser system and the plasma nozzle are arranged relative to one another and configured in such a way that the laser beam emerges from the nozzle head of the plasma nozzle during operation, this object is solved according to the invention in that the nozzle head can be rotated about an axis of rotation which extends at an angle and/or offset relative to the plasma jet emerging from the nozzle head during operation and/or relative to the laser beam emerging from the nozzle head during operation.

It has been found that the area of influence of the plasma jet and/or the laser beam on the workpiece surface can be increased in this way. In this way, for example, the plasma jet can be made to act over a larger spatial area and decompose or transform any substances detached from the workpiece surface so that there no re-contamination of the worked workpiece surface occurs. In addition or in the alternative, it can be achieved in this way, for example, that the laser beam acts on a larger area of the workpiece surface so that larger surface areas can be worked or treated more effectively. By additionally moving the rotatable nozzle head relative to the workpiece surface, for example, a wide surface strip can be worked.

In addition, it was found that a more uniform working of the workpiece surface can be achieved in this way. In this way, the material properties of the surface can be influenced in a more targeted manner or material removal and thus cleaning can be carried out more uniform without, for example, locally over treated areas occurring.

The device is for working a surface of a workpiece with a laser beam. Working the surface of a workpiece can involve cleaning the surface, for example of organic contaminants. Such contaminants can be easily removed with a laser beam, but are easily returned to the surface. The plasma jet can be used to decompose or oxidize the organic contaminants removed by the laser beam, preventing the surface from becoming contaminated again. In conjunction with a rotatable nozzle head, a larger workpiece surface can be effectively cleaned of contaminants and recontamination prevented.

The device comprises a laser system for providing the laser beam. The laser system can therefore be used to provide the laser beam with which the surface of a workpiece can be worked. The laser system can comprise a laser source, in particular a solid-state laser such as a fiber laser. Instead of its own laser source, the laser system can also have an optical fiber that can be used to guide a laser beam from an external laser source into the laser system.

Furthermore, the laser system may comprise a light guiding system for guiding the laser beam, wherein the light guiding system may comprise one or more of the following elements, for example: laser channels, light guides, in particular fiber light guides such as glass fibers, optical elements such as mirrors, semi-transparent mirrors, lenses and/or beam splitters. Light guides enable particularly simple and geometrically flexible guidance of the laser light. Preferably, the laser system has further optical elements to direct and/or focus the laser beam onto the surface to be worked. Suitable optical elements for this purpose include mirrors, in particular curved mirrors, or lenses.

The device also comprises a plasma nozzle which is configured to generate an atmospheric plasma jet. In the present case, a plasma jet is understood to be a directed gas jet that is at least partially ionized. An atmospheric plasma jet is understood to be a plasma jet which is operated under atmospheric pressure, i.e. in which the plasma jet is directed into an environment whose pressure is essentially at atmospheric pressure or close to atmospheric pressure, for example in the range from 800 to 1300 mbar.

The plasma nozzle has a nozzle head from which a plasma jet generated in the plasma nozzle emerges during operation. For this purpose, the nozzle head has, in particular, at least one plasma outlet opening through which the plasma jet generated in the plasma nozzle can exit the nozzle head. The orientation and geometric design of the nozzle head and/or the plasma outlet opening can be used to specify the outlet location and the jet direction of the plasma jet. The nozzle head may also have several plasma outlet openings from which a plasma jet generated in the plasma nozzle emerges during operation. In this way, the plasma jet can be distributed over a larger area and/or the intensity of the plasma effect on the workpiece surface can be varied.

The laser system and the plasma nozzle are arranged relative to one another and configured in such a way that the laser beam emerges from the nozzle head during operation. For this purpose, the plasma nozzle is in particular designed such that the laser beam provided by the laser system is guided through the plasma nozzle and can emerge from the nozzle head.

Preferably, the plasma nozzle has a hollow electrode through which the laser beam can be guided. This enables a simplified design of the nozzle head. In addition, a separate construction for guiding the laser beam through the nozzle head, for example a separately formed laser channel, can be dispensed with in this way.

The nozzle head can be rotated about an axis of rotation. For example, the nozzle head can be designed to rotate relative to the rest of the plasma nozzle. However, it is also conceivable that the nozzle head is designed to be rotatable together with another part of the plasma nozzle or together with the entire plasma nozzle. For this purpose, the nozzle head can be designed to be rotationally fixed with the plasma nozzle or the co-rotating part thereof.

The axis of rotation runs at an angle and/or offset to the plasma jet emerging from the nozzle head during operation and/or to the laser beam emerging from the nozzle head during operation.

Accordingly, for example, the axis of rotation can run at an angle and/or offset to the plasma jet emerging from the nozzle head during operation. In this way, the impact area of the plasma jet can be enlarged so that substances detached from a workpiece surface by the laser beam can interact with the plasma jet over a larger area, in which they can be decomposed and/or transformed in order to reduce contamination of the workpiece surface. By rotating the nozzle head, the plasma jet can in particular travel along a circular path on the workpiece surface, which can be superimposed with a relative movement between the nozzle head and the workpiece surface, for example, so that a strip-shaped impact area of the plasma jet is created on the workpiece surface.

In order to arrange the axis of rotation offset to the plasma jet emerging from the plasma outlet opening, the axis of rotation may, for example, run outside a plasma outlet opening of the nozzle head intended for the outlet of the plasma jet. In order to arrange the axis of rotation at an angle to the plasma jet emerging from the plasma outlet opening, the axis of rotation may, for example, run at an angle in the range from 3º to 75°, preferably 5° to 45°, to the plasma jet emerging from the nozzle head during operation.

Preferably, the nozzle head is designed such that the plasma jet emerges offset and/or at a certain angle to the axis of rotation of the nozzle head. For this purpose, the nozzle head may in particular have a plasma outlet opening to which a plasma channel provided inside the nozzle head extends. By arranging the plasma outlet opening offset to the axis of rotation, the axis of rotation can be arranged offset to the plasma jet. In addition or in the alternative, the direction of extension and/or curvature of the plasma channel can be adapted such that the plasma jet leaves the plasma outlet opening at an angle to the axis of rotation. In addition or in the alternative, deflection elements may also be provided which are designed and arranged in such a way that the plasma jet exits the plasma outlet opening at an angle to the axis of rotation.

The nozzle head can be designed in such a way that the laser beam passes through the plasma channel, at least in sections. This can simplify the geometry of the nozzle head, as no separate laser channel is required for the laser beam, at least in sections.

In addition or in the alternative, the axis of rotation may run at an angle and/or offset to the laser beam emerging from the nozzle head during operation. In this way, the impact area of the laser beam can be increased so that substances, in particular contaminants, can be effectively removed from a larger surface area of the workpiece surface.

According to the invention, the above object is furthermore solved at least in part by a method of operating the device described above or an embodiment thereof, in which an atmospheric plasma jet is generated with the plasma nozzle so that it emerges from the nozzle head, in which a laser beam is provided with the laser system so that it emerges from the nozzle head, and in which the nozzle head is rotated about the axis of rotation.

The device and method described above can be used, for example, to clean the surface of a workpiece.

Various embodiments of the device and the method are described below, whereby the individual embodiments are applicable to both the device and the method and can also be combined with one another.

In a first embodiment, the nozzle head has a plasma outlet opening from which the plasma jet emerges during operation, and the laser system and the plasma nozzle are arranged relative to one another and configured in such a way that the laser beam emerges from the plasma outlet opening during operation. In this way, for example, the laser beam and the plasma jet can impact the workpiece surface to be worked together and thus, for example, the particles removed from the surface by the laser beam can be effectively and immediately transformed by the plasma jet. This allows effective cleaning of the surface in a simple manner. Furthermore, the design of the nozzle head can be simplified, as a common plasma outlet opening can be provided for the plasma jet and the laser beam.

In a further embodiment, the laser system is configured to continuously vary the beam direction of the laser beam in such a way that the position of the laser beam in the cross-section of the plasma outlet opening or the laser outlet opening changes continuously. In a corresponding embodiment of the method, the direction of the laser beam is continuously varied in such a way that the position of the laser beam in the cross-section of the plasma outlet opening or the laser outlet opening varies continuously. In this way, the area worked by the laser beam on the surface of the workpiece can be increased.

Continuous variation means that the beam direction of the laser beam is continuously changed. For example, the laser system may have mirror optics with a movable mirror that can be used to vary the beam direction of the laser beam.

The laser system varies the beam direction of the laser beam preferably cyclically, for example in such a way that the position of the laser beam in the cross-section of the plasma outlet opening or laser outlet opening moves back and forth in a line or moves in a circle.

In a further embodiment, the nozzle head has a plasma outlet opening, from which the plasma jet emerges during operation, and a laser outlet opening separate from the plasma outlet opening, and the laser system and the plasma nozzle are arranged relative to one another and configured in such a way that the laser beam emerges from the laser outlet opening during operation.

By providing a laser outlet opening that is separate from the plasma outlet opening, greater flexibility can be achieved in the interaction between the plasma jet and the laser beam. For example, it is possible to have the plasma jet impinge spatially offset to the laser beam on an area of the workpiece surface to be worked. Among other things, this makes it possible to take into account that the material removed by the laser beam is distributed in a preferred direction with a time delay after exposure to the laser beam. The plasma jet can then be flexibly aligned accordingly.

In addition, the interaction of the plasma jet with the laser beam can be reduced in this way if necessary. In particular, a negative influence on the intensity of the laser beam by the plasma jet, especially absorption of the laser beam, can be reduced or even avoided. This allows more intensity of the laser beam to be applied to the surface to be worked. Reduced interaction also advantageously leads to less laser scattered light and improved focusability of the laser beam on the workpiece surface.

A laser channel can be provided in the nozzle head, at least in sections, which leads to the laser outlet opening. In this way, the laser beam can be protected from external interference and widening of the laser beam can be avoided.

In a further embodiment, the laser outlet opening has a smaller cross-sectional area than the plasma outlet opening. In a further embodiment, a channel leading to the laser outlet opening has a smaller cross-sectional area than a plasma channel leading to the plasma outlet opening. In this way, the proportion of an unintentional part of the plasma jet emerging from the laser outlet opening can be reduced. Preferably, the ratio of the cross-sectional area of the plasma outlet aperture to the cross-sectional area of the laser outlet aperture and/or the ratio of the cross-sectional area of the plasma channel leading to the plasma outlet aperture to the cross-sectional area of the channel leading to the laser outlet aperture is at least two, preferably at least four. The cross-sectional area of the plasma outlet opening can be in the range from 7 to 100 mm², for example. The cross-sectional area of the laser outlet opening can, for example, be in the range from 0.2 to 20 mm², preferably 0.2 to 7 mm².

Alternatively, the laser outlet opening can also have a cross-sectional area of the same size or larger than the plasma outlet opening, for example if the laser system varies the beam direction of the laser beam in such a way that the position of the laser beam moves in the cross-section of the laser outlet opening, for example moving back and forth along a line or moving in a circle.

In a further embodiment, the laser beam emerging from the nozzle head passes through the axis of rotation. In this way, the design complexity of the device can be reduced, since rotating elements of the laser system can be partially or completely dispensed with. If the nozzle head has a laser outlet opening, this can be achieved in particular by the axis of rotation running through the laser outlet opening. If the nozzle head has a plasma outlet opening through which the laser beam exits the nozzle head, this can be achieved in particular by the axis of rotation running through the plasma outlet opening.

In a further embodiment, the plasma nozzle has a housing with a housing axis and the axis of rotation coincides with the housing axis. In this way, a structurally simple and space-saving device is achieved, which has a low susceptibility to imbalances and a comparatively low moment of inertia due to the alignment of the axis of rotation with the housing axis and is therefore well suited for high rotational speeds.

In a further embodiment, the plasma nozzle has a housing with a housing axis and the axis of rotation runs parallel offset to the housing axis. In this way, a greater distance can be achieved between a plasma outlet opening and/or laser outlet opening provided on the nozzle head and the axis of rotation, so that the impact area of the plasma jet and/or the laser beam is increased.

In a further embodiment, the housing axis runs through the laser outlet opening. This enables simplified guidance of the laser beam to the nozzle head and therefore a particularly simple design of the device. In particular, the plasma nozzle can have a hollow electrode through which the laser beam can be guided. The hollow electrode preferably runs along the axis of the housing. Such a design enables a highly rotationally symmetrical construction, which can be advantageous for uniform generation of the plasma jet in the device and thus for its uniform operation. However, the hollow electrode may also be arranged offset to the housing axis to allow the laser beam to emerge from the nozzle head parallel to the housing axis. This allows increased flexibility with regard to the design of the device.

In one embodiment, the laser beam emerges from the nozzle head, in particular from the plasma outlet opening or from the laser outlet opening, at an angle to the axis of rotation. In this case, the housing axis may run at an angle to the axis of rotation, run parallel to it or coincide with it. In this embodiment, the laser system and the plasma nozzle are arranged to one another and configured in such a way that the laser beam emerges from the nozzle head at an angle to the axis of rotation.

In one embodiment, the housing axis runs through the plasma outlet opening. This enables a simpler, preferably highly rotationally symmetrical, design of the device.

In a further embodiment, the device has a further plasma nozzle which is configured to generate a further atmospheric plasma jet, which further plasma nozzle has a further nozzle head, from which a plasma jet generated in the further plasma nozzle emerges during operation, wherein the nozzle head and the further nozzle head can be rotated together about the axis of rotation.

In this way, the workpiece surface can be treated simultaneously with several plasma nozzles. This enables a larger surface area to be treated or a given surface to be treated more quickly.

Preferably, the plasma nozzle and the further plasma nozzle have a respective housing axis that is offset to the axis of rotation or runs at an angle to it. In this way, the impact area of the plasma jet and of the further plasma jet and/or of the laser beam is significantly increased. The nozzle head and the further nozzle head or the plasma nozzle and the further plasma nozzle are preferably connected to each other in a rotationally fixed manner. It is further preferred that the nozzle head and the further nozzle head or the plasma nozzle and the further plasma nozzle are arranged opposite each other with respect to the axis of rotation. In this way, an imbalance during rotation around the axis of rotation can be reduced.

Preferably, a common rotary drive is provided for the nozzle head and the further nozzle head or for the plasma nozzle and the further plasma nozzle to rotate around the axis of rotation. This allows a cost-effective and reliable design of the device.

The further nozzle head preferably has a plasma outlet opening from which the further plasma jet emerges during operation. The axis of rotation preferably runs at an angle and/or offset to the plasma jet emerging from the nozzle head during operation.

It may be provided that the plasma jet and the further plasma jet emerge from the respective nozzle head at the same or a similar angle to the axis of rotation. In particular, the plasma jet and the further plasma jet can be directed inwards, i.e. towards the axis of rotation, or outwards, i.e. away from the axis of rotation. In this way, the intensity of the effect of the plasma jets can be increased. Alternatively, it is also conceivable that one of the plasma jet and the further plasma jet is directed inwards and the other outwards. In this way, the impact area of the plasma jets can be increased.

In a further embodiment of the device, the laser system, the plasma nozzle and the further plasma nozzle are arranged relative to one another and configured in such a way that the laser beam emerges from both the nozzle head and the further nozzle head during operation. For this purpose, for example, a beam splitter can be provided, which is configured and arranged to split a laser beam provided by the laser system into two or more partial beams. In particular, one or more optical elements, in particular optically diffractive elements, such as lenses, light guide beam splitters or semi-transparent mirrors, may be used as beam splitters. In particular, the laser system may comprise a light guiding system that guides one or more partial beams of the laser beam to the nozzle head and one or more further partial beams of the laser beam to the further nozzle head. By providing one laser system for both plasma nozzles or nozzle heads, the device can be manufactured more cost-effectively.

The laser system and the further plasma nozzle may be arranged relative to one another and configured in such a way that the laser beam emerges from a plasma outlet opening of the further nozzle head during operation. The laser system and the further plasma nozzle may also be arranged relative to one another and configured in such a way that, during operation, the laser beam emerges from a laser outlet opening of the further nozzle head that is separate from the plasma outlet opening. These embodiments have essentially the same advantages as those already described above for the plasma outlet opening or the laser outlet opening of the one plasma nozzle.

In a further embodiment, the device has a further laser system for providing a further laser beam, whereby the further laser system and the further plasma nozzle are arranged relative to one another and configured in such a way that, during operation, the further laser beam emerges from the further nozzle head. In this way, the complexity of the respective laser systems can be reduced, as there is no need for beam splitters or complicated beam guides, for example. In addition, this embodiment allows the use of laser beams with different parameters, for example different intensities or wavelengths, so that more flexible working of the workpiece surface is possible. For example, it is possible in this way to more effectively remove different types of contaminants from the workpiece surface, which are easier to remove using radiation of different wavelengths, for example.

The further laser system can comprise optical elements, for example lenses or mirrors, for aligning and/or focusing the further laser beam onto the workpiece surface.

In one embodiment, the device has a rotary drive that is configured to rotate the nozzle head and/or the further nozzle head around the axis of rotation. In this way, the rotation of the nozzle head can be controlled in a targeted manner, preferably with a predeterminable rotation frequency. The rotation frequency is preferably in the range of 100 to 5000 revolutions per minute, more preferably 500 to 3500 revolutions per minute. At these rotation frequencies, a particularly uniform effect of the plasma jet and/or laser beam can be achieved. The rotary drive may be configured to rotate the nozzle head relative to the remaining part of the plasma nozzle about the axis of rotation and/or to rotate the further nozzle head relative to the remaining part of the further plasma nozzle about the axis of rotation. Furthermore, the rotary drive may be configured to rotate a part of the plasma nozzle or the entire plasma nozzle together with the nozzle head about the axis of rotation and/or to rotate a part of the plasma nozzle or the entire plasma nozzle together with the nozzle head about the axis of rotation.

It is also conceivable that a rotary drive configured to rotate the nozzle head and/or the plasma nozzle and a further rotary drive configured to rotate the further nozzle head and/or the further plasma nozzle are provided.

It may be provided that the laser system or a part of it, for example a laser source of the laser system, is arranged in such a way that it is not rotated by the rotary drive. This enables greater stability of the overall system.

In a further embodiment, the laser system is configured to guide the laser beam at least in sections along the axis of rotation. In this way, the laser beam can be coupled along the axis of rotation into the system of components of the device rotating about the axis of rotation, i.e. the nozzle head, possibly the remaining plasma nozzle and possibly further rotating components of the device, so that the laser beam can be provided, in particular by a laser source outside the system of rotating components of the device. In particular, it is not necessary in this way for the laser source to rotate with the nozzle head. In order to guide the laser beam to the nozzle head, the device may comprise one or more mirrors that rotate with the nozzle head, via which the laser beam is guided from its sectional path along the axis of rotation to the nozzle head.

In a further embodiment, the plasma nozzle is configured to generate the atmospheric plasma jet by means of an arc-like discharge in a working gas, wherein the arc-like discharge is preferably generated by applying a high-frequency high voltage between electrodes. In this way, a plasma jet can be generated that can be easily focused and is well suited for the transformation or decomposition of substances detached from a surface. In addition, a plasma jet generated in this way, especially when using a high-frequency high voltage, has a relatively low temperature just a few centimeters after emerging from the plasma nozzle, so that damage to the workpiece surface by the plasma jet can be prevented.

In addition, a low temperature of the plasma jet can be achieved through pulsed plasma operation.

The high-frequency high voltage for generating a high-frequency arc-like discharge may, for example, have a voltage amplitude in the range of 1-100 kV, preferably 1-50 kV, more preferably 1-10 kV, and a frequency of 1-300 kHz, in particular 1-100 kHz, preferably 10-100 kHz, more preferably 10-50 KHz.

In a further embodiment, the device has a controller configured to control the device according to the method described above or one of the described embodiments thereof. The controller may, for example, have at least one processor and a memory with instructions, the execution of which on the at least one processor causing the device to be controlled according to the method or an embodiment thereof. In particular, the controller may be configured to control the device, for example to control the rotation frequency.

### BRIEF DESCRIPTION OF THE DRAWINGS

Further features and advantages of the device and the method emerge from the following description of exemplary embodiments, with reference being made to the attached drawings.

### In the Drawings:

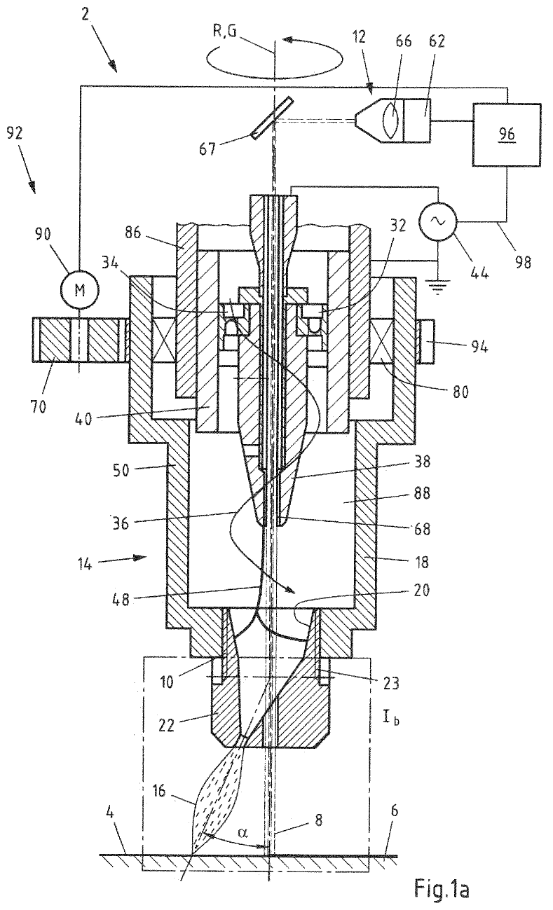

FIG. 1a-c show a first exemplary embodiment of the device and of the method for working a surface of a workpiece with a laser beam,

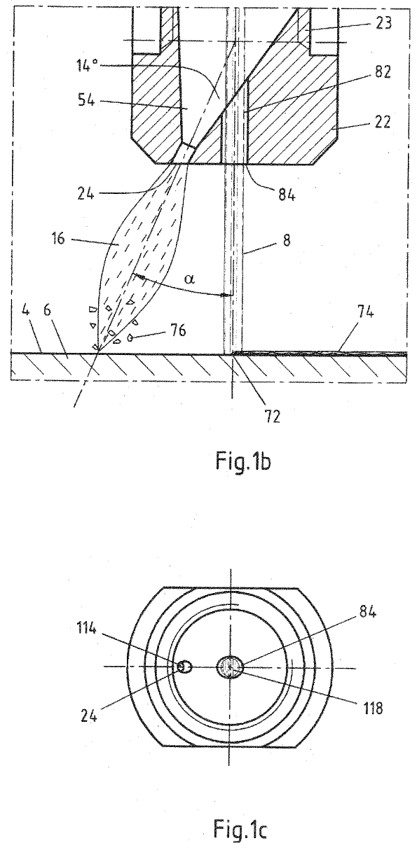

FIG. 2 shows a second exemplary embodiment of the device and of the method for working a surface of a workpiece with a laser beam,

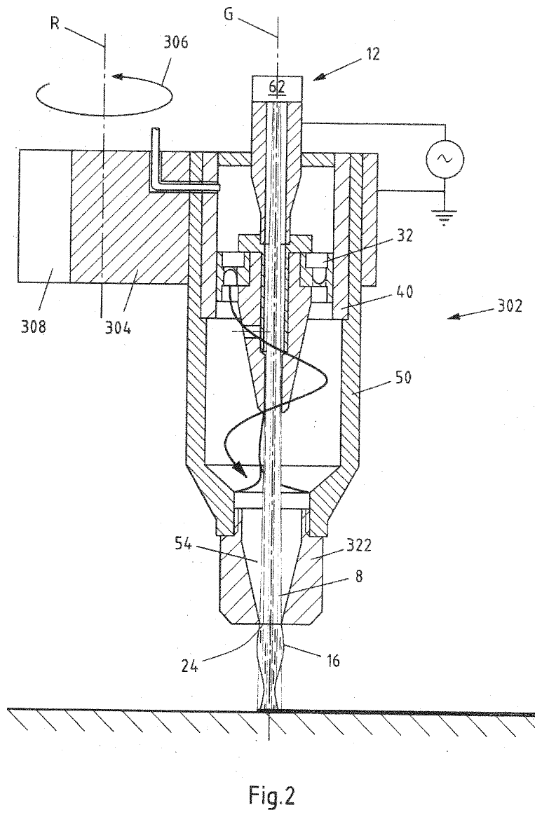

FIG. 3 shows a third exemplary embodiment of the device and of the method for working a surface of a workpiece with a laser beam,

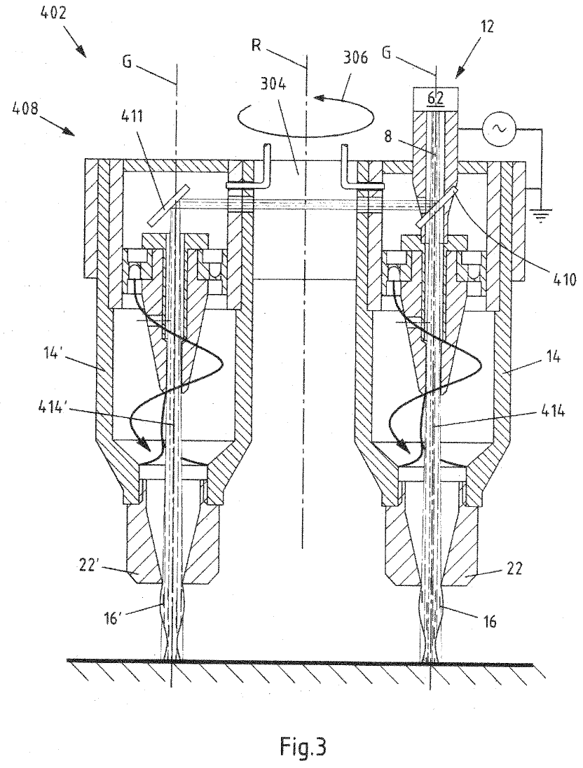

FIG. 4 shows a fourth exemplary embodiment of the device and of the method for working a surface of a workpiece with a laser beam,

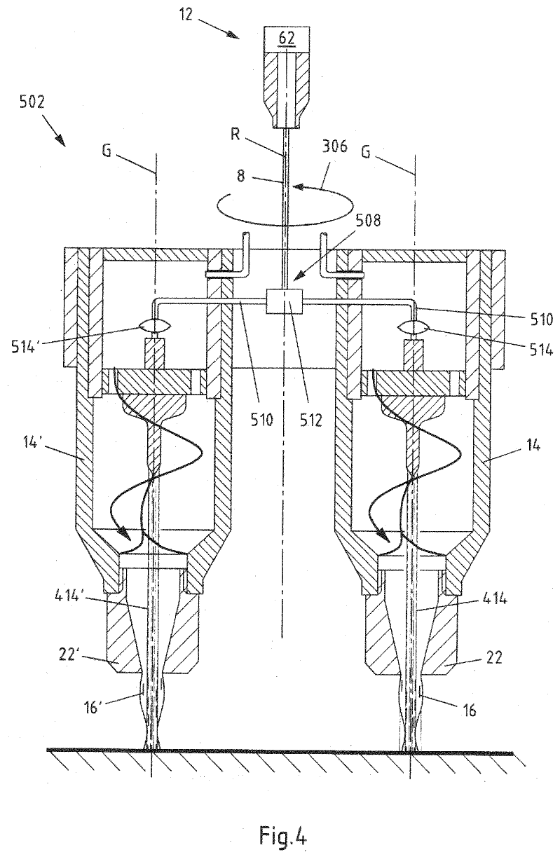

FIG. 5 shows a fifth exemplary embodiment of the device and of the method for working a surface of a workpiece with a laser beam and

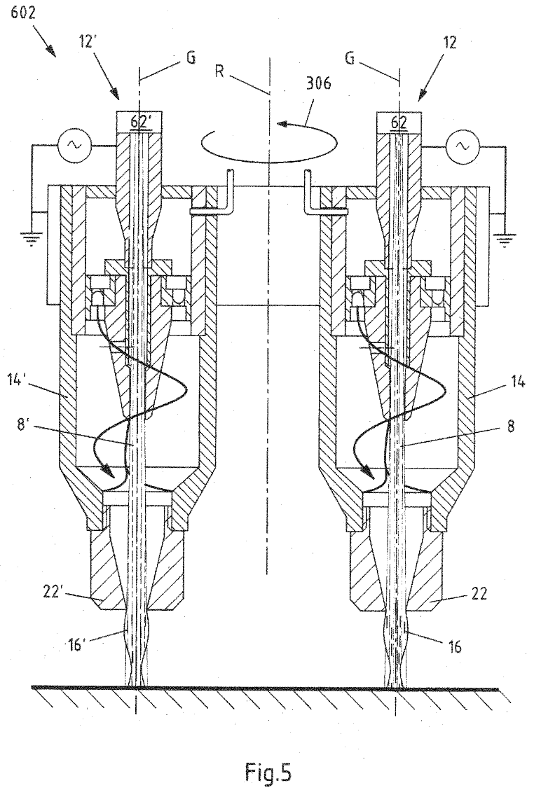

FIG. 6 shows a sixth exemplary embodiment of the device and of the method for working a surface of a workpiece with a laser beam.

### DESCRIPTION OF THE INVENTION

FIGS. 1a-c show a schematic representation of a first exemplary embodiment of the device and of the method. FIG. 1a shows a schematic sectional view from the side and FIG. 1b shows an enlarged view of the part of FIG. 1a labeled Ib. FIG. 1c shows a view of the nozzle head of the device from below.

The device 2 for working a surface 4 of a workpiece 6 with a laser beam 8 comprises a plasma nozzle 14 configured to generate a plasma jet 16. The plasma nozzle 14 has a tubular housing 50 made of metal, which is widened in diameter in its upper region shown in the drawing and is rotatably mounted on a fixed support tube 86 by means of a bearing 80 and forms a nozzle tube 18 in its lower region shown in the drawing. The housing 50 has a housing axis G which runs centrally through the nozzle tube 18.

A nozzle channel 88 is formed inside the housing 50, which nozzle channel leads from the upwardly open end of the support tube 86 to an exchangeable nozzle head 22, which is mounted at the lower end of the nozzle tube 18 in the drawing. The nozzle head 22 is made of metal and has an external thread 23, with which the nozzle head 22 is screwed into an internal thread 10 of the nozzle tube 50. The nozzle head 22 also has a plasma channel 54, which leads to a plasma outlet opening 24, from which the plasma jet 16 generated in the plasma nozzle 14 emerges during operation.

An electrically insulating ceramic tube 40 is inserted into the support tube 86. During operation, a working gas, for example air, is introduced through the support tube 86 and the ceramic tube 40 into the nozzle channel 88. With the aid of a swirl device 32 inserted into the ceramic tube 40, the swirl device having holes 34 inclined in the circumferential direction, the working gas is swirled such that it flows in a vortex through the nozzle channel 88 to the nozzle head 22. The working gas therefore flows through the downstream part of the nozzle tube 18 in the form of a vortex 36, the core of which runs along the longitudinal axis of the nozzle tube 18.

An inner electrode 38 in the form of a pin-shaped hollow electrode is mounted on the swirl device 32, which hollow electrode extends coaxially in the nozzle tube 18 in the direction of the nozzle head 22 and has an inner channel 68. The inner electrode 38 is electrically connected to the swirl device 32. The swirl device 32 is electrically insulated from the nozzle tube 18 by a ceramic tube 40. The nozzle tube 18 is earthed via the bearing 80 and the support tube 86 and forms a counter-electrode.

During operation, a high-frequency high voltage, which is generated by a transformer 44, is applied between the inner electrode 38 and the nozzle tube 18, which acts as a counter electrode. The high-frequency high voltage may have a voltage amplitude in the range of 1-100 kV, preferably 1-50 kV, more preferably 1-10 kV, and a frequency of 1-300 kHz, in particular 1-100 kHz, preferably 10-100 kHz, more preferably 10-50 kHz. The high-frequency high voltage may be a high-frequency AC voltage, but also a pulsed DC voltage or a superposition of both voltage forms. The high-frequency high voltage generates a high-frequency discharge in the form of an arc 48 between the inner electrode 38 and the nozzle tube 18.

The terms “arc” and “arc discharge” are used here as a phenomenological description of the discharge, as the discharge occurs in the form of an arc. The term “arc” is also used elsewhere as a form of discharge for DC discharges with essentially constant voltage values.

In the present case, however, we are dealing with a high-frequency discharge in the form of an arc, i.e. a high-frequency arc discharge.

Due to the swirling flow of the working gas, this arc 48 is channeled in the vortex core on the axis of the nozzle tube 18, so that it only branches out to the wall of the nozzle tube 18 in a lower, tapering area 20 of the nozzle tube at the transition to the nozzle head 22.

The working gas, which rotates at high flow velocity in the area of the vortex core and thus in the immediate vicinity of the arc 48, comes into intimate contact with the arc 48 and is thus partially brought into the plasma state, so that an atmospheric plasma jet 16 enters the plasma channel 54 of the nozzle head 22 and exits the plasma nozzle from the plasma outlet opening 24.

The plasma nozzle 14 can be rotated about an axis of rotation R by the rotatable bearing on the support tube 86. In the device 2, the axis of rotation R coincides with the housing axis G of the plasma nozzle 14.

The plasma channel 54 of the nozzle head 22 is shaped in such a way that the plasma jet 16 emerges from the plasma outlet opening 24 at an angle a to the housing axis G and thus to the rotation axis R. Furthermore, the plasma outlet opening 24 is positioned in such a way that the plasma jet 16 emerges from the plasma outlet opening 24 offset to the axis of rotation R. In this way, the axis of rotation R runs at an angle and offset to the plasma jet 16 emerging from the nozzle head 22 during operation.

The angle a may be varied as required by exchanging the nozzle head 22. Instead of the nozzle head 22, a nozzle head may also be selected in which the plasma jet 16 emerges from the plasma outlet opening 24 parallel and offset to the axis of rotation R.

In order to rotate the plasma nozzle 16 about the axis of rotation R, a rotary drive 92 is provided which may, for example, comprise a motor 90 with a gear wheel 70 which meshes with an external gear wheel 94 arranged on the housing 50. The plasma jet 16 emerging at an angle from the plasma outlet opening 24 sweeps over a circular area on the workpiece surface 4 due to the rotation about the axis of rotation R, which circular area may superimpose itself to form a strip-shaped area on the workpiece surface 4 during a relative movement between the plasma nozzle 16 and the workpiece surface 4.

Furthermore, the device 2 has a laser system 12 with a laser source 62, which may be arranged above the plasma nozzle 14, for example. The laser source 62 provides a laser beam 8. As an alternative to the laser source 62, the device 2 may also have, for example, a light guide that is connected to an external laser source. Lens optics 66 and/or mirrors 67 may be provided, which are arranged and configured in such a way that the laser beam 8 generated by the laser source 62 is guided into the inner channel 68 of the hollow electrode 38.

The laser beam 8 passes through the inner channel 68 and, after exiting the inner channel 68, passes through the lower part of the nozzle channel 88 into a laser channel 82 provided in the nozzle head 22 and positioned in alignment with the inner channel 68 of the hollow electrode 38, which opens into a laser outlet opening 84 through which the laser beam 8 exits the nozzle head 22. In the present example, the housing axis G and the rotation axis R run through the laser outlet opening 84. Furthermore, the laser source 62 is arranged in such a way that it remains at rest when the plasma nozzle 14 rotates, i.e. it does not rotate. In this way, a structurally simple and reliable device is provided.

The mirror 67 may, for example, be designed as a continuously pivoting mirror in order to continuously vary the beam direction of the laser beam in such a way that the position of the laser beam in the cross-section of the laser outlet opening varies continuously, for example back and forth or on a circular path. In this way, the laser beam may be used to act on a larger area of the surface 4.

During operation, the laser beam 8 and the plasma jet 16 emerge from the nozzle head 22 from the laser outlet opening 84 and the plasma outlet opening 24, respectively, and reach the surface 4 of the workpiece 6. The workpiece surface 4 is worked by the impinging laser beam 8 at the point 72 in that material such as a contamination 74 on the surface 4 is removed, for example vaporized, by the laser beam 8. The material 76 vaporized by the laser beam 8 is decomposed or transformed by the plasma jet 16 so that it cannot re-deposit on the surface 4. In this way, in particular organic contamination may be removed from a surface 4 since the organic material removed by the laser beam 8 is decomposed and oxidized by the plasma jet 16.

While the plasma jet 16 typically has a diameter of several millimeters, the laser beam 8 typically has a diameter of less than 1 mm. The cross-sectional area 114 of the plasma outlet opening 24 may therefore be larger than the cross-sectional area 118 of the laser outlet opening 84, for example by a factor of four or more. Alternatively, as shown in FIGS. 1a-c, the laser outlet opening 84 may also be the same size or larger than the plasma outlet opening 24, for example when the position of the laser beam 8 in the cross-section of the laser outlet opening 84 is continuously varied as described above.

Due to the rotation of the plasma nozzle 14, the laser spot on the workpiece surface 4 is surrounded by a plasma ring, so that material 76 removed by the laser beam 8 can be encompassed and converted as completely as possible by the plasma jet 16. Furthermore, the relative movement between plasma nozzle 14 and surface 4 has the effect that the plasma jet 16 also sweeps over the area of the laser spot and can therefore transform or decompose material remaining directly in the area of the laser spot.

If the device 2 or the plasma nozzle 14 is moved along the surface 4 of the workpiece 6 or, conversely, the workpiece 6 is moved along the device 2 or the plasma nozzle 14, a uniform treatment of the surface 4 of the workpiece 6 is achieved on a strip whose width corresponds to the diameter of the circle described by the plasma jet 16 on the workpiece surface 4. The width of the covered area can be influenced by varying the distance between the nozzle head 22 and the workpiece 6.

The device 2 may further comprise a controller 96, which is preferably connected via communication links 98 to the rotary drive 92 and the laser source 62 as well as to the transformer 44 and the working gas source (not shown). By means of the controller 96, for example, the working gas supply, the provision of the laser beam 8 and the plasma jet 16 as well as the rotation of the nozzle head 22 can be controlled. In this way, the rotation speed may be adapted to the working gas supply, for example, or the intensity of the laser beam 8 may be easily varied via the control device 96 depending on the surface 4 to be worked.

FIG. 2 shows a second exemplary embodiment of the device and of the method in schematic sectional view from the side.

The device 302 has a similar structure to the device 2. Corresponding components are provided with the same reference numerals and reference is made in this respect to the explanations above for FIGS. 1a-c.

The device 302 differs from the device 2 in that the axis of rotation R does not coincide with the housing axis G but is offset parallel thereto. Accordingly, the tubular housing 50 of the plasma nozzle 302 is not mounted on a support tube 86 via a bearing 80, but is connected in a rotationally fixed manner to a rotation arm 304, which is rotatable about the axis of rotation R by means of a rotation drive 306. A counterweight 308 is provided on the side of the rotation arm 304 opposite the plasma nozzle 14 in order to avoid an imbalance. In the device 302, the ceramic tube 40 with the swirl device 32 is inserted directly into the tubular housing 50.

Furthermore, instead of the nozzle head 22, the device 302 has a nozzle head 322 with a plasma outlet opening 24, which is arranged centrally on the nozzle head 22, so that the housing axis G of the housing 50 extends through the plasma outlet opening 24. In this way, the plasma jet 16 generated in the plasma nozzle 14 and the laser beam 8 introduced into the hollow electrode 38 by the laser system 12 emerge together from the nozzle head 322 through the plasma outlet opening 24. The axis of rotation R is correspondingly offset to the plasma jet 16 and laser beam 8 emerging from the nozzle head 322.

FIG. 3 shows a third exemplary embodiment of the device and the method in schematic sectional view from the side.

The device 402 has a similar structure to the device 302. Corresponding components are provided with the same reference numerals and reference is made in this respect to the explanations above for FIG. 2 and FIG. 1a-c.

The device 402 differs from the device 302 in that a further plasma nozzle 14′ is provided for generating a further plasma jet 16′. The structure and functioning of the plasma nozzle 14′ correspond to the structure and functioning of the plasma nozzle 14.

The plasma nozzle 16 and the further plasma nozzle 16′ are mounted on opposite sides of the rotation arm 304. A counterweight 308 can be dispensed with in this way.

The laser system 12 is arranged and configured in such a way that the laser beam 8 emerges from the respective nozzle heads 22, 22′ of the plasma nozzles 14 and 14′ during operation. For this purpose, the laser system 12 comprises a light guiding system 408 with a beam splitter 410 in the form of a semi-transparent mirror and further optical elements such as mirrors 411, with which the partial beams 414, 414′ generated with the beam splitter 410 are guided to the nozzle heads 22, 22′.

FIG. 4 shows a fourth exemplary embodiment of the device and the method in schematic sectional view from the side.

The device 502 has a similar structure to the device 402. Corresponding components are provided with the same reference numerals and reference is made in this respect to the explanations above for FIG. 3, FIG. 2 and FIG. 1a-c.

The device 502 differs from the device 402 in that the in-coupling of the laser beam 8 takes place along the axis of rotation R. In this way, it is not necessary to rotate the laser source 62 of the laser system 12.

The device 502 further differs from the device 402 by a different light guiding system 508 instead of the light guiding system 408. The light guiding system 508 has light guides 510 in the form of glass fibers, with which the laser beam 8 is guided from the laser source 12 via a beam splitter 512 to optical elements 514, 514′, with which the respective partial beams 414, 414′ of the laser beam 8 are coupled out from the light guides and guided through the plasma nozzles 14, 14′ to the nozzle heads 22, 22′, from which they emerge together with the respective plasma jet 16, 16′.

FIG. 5 shows a fifth exemplary embodiment of the device and the method in schematic sectional view from the side.

The device 602 has a similar structure to the device 402. Corresponding components are provided with the same reference numerals and reference is made in this respect to the explanations above for FIG. 3, FIG. 2 and FIG. 1a-c.

The device 602 differs from the device 402 in that, in addition to the laser system 12, a further laser system 12′ with a further laser source 62′ is provided and in that the laser system 12 and the further laser system 12′ are each arranged and configured in such a way that the respective laser beam 8, 8′ emerges from the respective nozzle head 22, 22′. Accordingly, the device 602 has a respective laser system 12, 12′ for the plasma nozzle 14 and the further plasma nozzle 14′. In this way, for example, two laser beams 8, 8′ with different optical properties may be provided for working the surface 4.

FIG. 6 shows a sixth exemplary embodiment of the device and the method in schematic sectional view from the side.

The device 802 has a similar structure to the device 402. Corresponding components are provided with the same reference numerals and reference is made in this respect to the explanations above for FIG. 3, FIG. 2 and FIG. 1a-c.

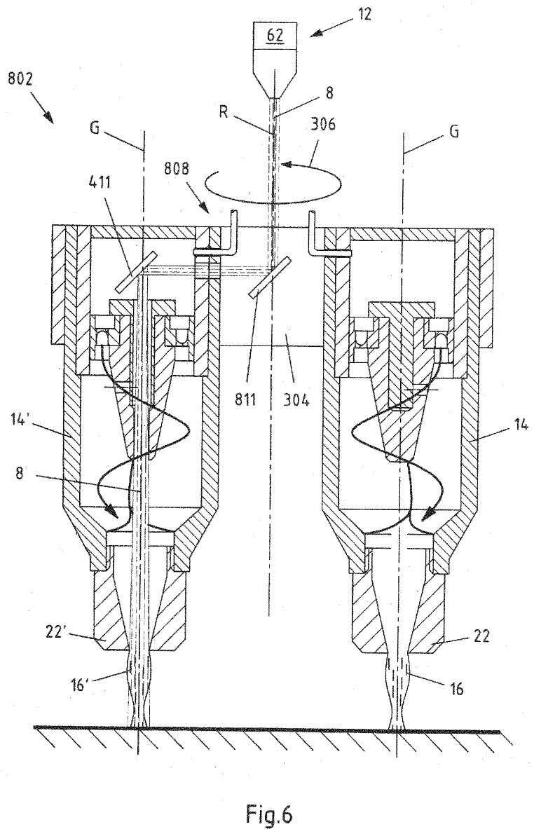

The device 802 differs from the device 402 in that the in-coupling of the laser beam 8 takes place along the axis of rotation R. In this way, it is not necessary to rotate the laser source 62 of the laser system 12. The laser system 12 has a light guiding system 808 with optical elements such as mirrors 811, 411, with which the laser beam 8 is guided to the nozzle head 22′. The mirrors 811, 411 rotate together with the plasma nozzle 14′ about the axis of rotation R, so that the laser beam 12 is guided to the nozzle head 22′ at any angular position. FIG. 8 shows an embodiment in which the laser beam 8 only emerges from the nozzle head 22′. However, by providing a semi-transparent mirror above mirror 811 and a mirror corresponding to the mirror 411 on the plasma nozzle 14 and by a design of the plasma nozzle 14 corresponding to the plasma nozzle 14′, it may also be achieved that the laser beam 8 emerges from both nozzle heads 22, 22′.

1-15. (canceled)

16. A device for working a surface of a workpiece with a laser beam,
with a laser system for providing the laser beam and
with a plasma nozzle which is configured to generate an atmospheric plasma jet,
wherein the plasma nozzle has a nozzle head from which a plasma jet generated in the plasma nozzle emerges during operation, and
wherein the laser system and the plasma nozzle are arranged relative to one another and configured in such a way that the laser beam emerges from the nozzle head of the plasma nozzle during operation, wherein the nozzle head can be rotated about an axis of rotation which extends at an angle and/or offset to the plasma jet emerging from the nozzle head during operation and/or to the laser beam emerging from the nozzle head during operation, and
the device has a rotary drive which is configured to rotate the nozzle head about the axis of rotation (R).

17. The device according to claim 1, wherein the nozzle head has a plasma outlet opening from which the plasma jet emerges during operation, and in that the laser system and the plasma nozzle are arranged relative to one another and configured in such a way that the laser beam emerges from the plasma outlet opening during operation.

18. The device according to claim 1, wherein the nozzle head has a plasma outlet opening, from which the plasma jet emerges during operation, and a laser outlet opening separate from the plasma outlet opening, and that the laser system and the plasma nozzle are arranged relative to one another and configured in such a way that the laser beam emerges from the laser outlet opening during operation.

19. The device according to claim 3, wherein the laser outlet opening has a smaller cross-sectional area than the plasma outlet opening.

20. The device according to claim 3, wherein the axis of rotation (R) extends through the laser outlet opening.

21. The device according to claim 1, wherein the plasma nozzle has a housing with a housing axis (G) and the axis of rotation (R) coincides with the housing axis (G).

22. The device according to claim 1, wherein the plasma nozzle has a housing with a housing axis (G) and the axis of rotation (R) runs parallel offset to the housing axis (G).

23. The device according to claim 6, wherein the housing axis (G) runs through the laser outlet opening.

24. The device according to claim 1, wherein the device has a further plasma nozzle which is configured to generate a further atmospheric plasma jet, which further plasma nozzle has a further nozzle head from which, during operation, a further plasma jet generated in the further plasma nozzle emerges, the nozzle head and the further nozzle head can be rotated together about the axis of rotation (R).

25. The device according to claim 9, wherein the laser system, the plasma nozzle and the further plasma nozzle are arranged relative to one another and configured in such a way that the laser beam emerges both from the nozzle head and from the further nozzle head during operation.

26. The device according to claim 9, wherein the device has a further laser system for providing a further laser beam, the further laser system and the further plasma nozzle being arranged relative to one another and configured in such a way that the further laser beam emerges from the further nozzle head during operation.

27. The device according to claim 1, wherein the device has a rotary drive which is configured to rotate the further nozzle head about the axis of rotation (R).

28. The device according to claim 1, wherein the plasma nozzle is configured to generate the atmospheric plasma jet by means of an arc-like discharge in a working gas, the arc-like discharge preferably being generated by applying a high-frequency high voltage between electrodes.

29. The device according to claim 1, wherein the device comprises a controller configured to control the device according to a method.

30. A method of operating a device according to claim 1,
in which an atmospheric plasma jet is generated with the plasma nozzle so that it emerges from the nozzle head,
in which a laser beam is provided by the laser system so that it emerges from the nozzle head, and
in which the nozzle head is rotated about the axis of rotation (R).
